(19) United States
(12) Patent Application Publication
(10) Pub. No.: US 2003/0212576 A1
(43) Pub. Date: Nov. 13, 2003

(54) Medical information system

(76) Inventor: Back Kim, Lake Success, NY (US)

Correspondence Address: KENYON & KENYON, ONE BROADWAY, NEW YORK, NY, 10004, US

(21) Appl. No.: 10/141,311

(22) Filed: May 8, 2002

(51) Int. Cl. G06F 17/60

(52) U.S. Cl. 705/2

(57) ABSTRACT

A medical information system for facilitating the treatment of a patient by a clinician is provided. The medical information system may include a processor. The medical information system may include an input device readable by the processor. The medical information system may include a demographic information interface configured to allow the input of patient demographic information for the patient from the input device. The medical information system may include a medical history interface configured to allow the input of medical history information for the patient from the input device. The medical information system may include an examination interface configured to allow the input of examination information for the patient from the input device The medical information system may include a diagnosis interface configured to allow the clinician to select a diagnosis using the input device.

### BACKGROUND INFORMATION

A medical doctor's or other clinician's treatment of a patient may include many different tasks, some of which are performed by the doctor, others by persons assisting or working under the supervision of the doctor. These tasks include the collection and review of patient demographic and medical history information, the examination of the patient, the determination of one or more diagnoses, the ordering of tests, treatments, or prescribing of medication, and the completion of an examination record, including billing and/or insurance information. Computer or computer-aided systems have been developed to aid in some of these tasks.

In many clinics, patient charts and notes are maintained on paper files using standard paper charting techniques. For physicians with many patients, the paper work can often be overwhelming. Similar problems may be encountered by other clinicians, such as dentists or veterinarians. The extensive process of generating and finishing a clinical patient note without the use of computers is often time consuming and inefficient. At the same time, many clinicians are not highly computer literate or resist using computer tools that are not easy to use.

Electronic medical record systems (EMR) do exist that are usable by clinicians, but these systems are still time consuming and cumbersome to use. These systems may require manual generation and completion of findings reports. They may also require search for medication codes and/or diagnoses from books or separate databases.

Automated diagnosis systems exist, but are generally not integrated with patient record keeping tools. Many of such systems are highly specialized, with their use limited to a single specialized treatment area.

Standard diagnosis classifications and code sets exist and are commonly employed by clinicians. An example diagnosis code set is the ICD-9 standard. ICD stands for “international classification of diseases”. Another code set is the SNOMED universal insurance code set. Other standards are also in use in different clinical specialties, e.g., the DSM-IV for psychiatry and mental health professionals.

### BRIEF DESCRIPTION OF THE DRAWINGS

FIG. 1 illustrates an example high-level design for an example medical information system, according to an example embodiment of the present invention.

FIG. 2 illustrates an alternative example high-level design for the example medical information system.

FIG. 3 illustrates an example high-level patient interface provided as part of an example medical information system, according to an example embodiment of the present invention.

FIG. 4 illustrates an example office visit interface which may be provided as part of an example medical information system, according to an example embodiment of the present invention.

FIG. 5 illustrates an example patient demographic information interface provided as part of an example medical information system, according to an example embodiment of the present invention.

FIG. 6 illustrates an example medical history information interface provided as part of an example medical information system, according to an example embodiment of the present invention.

FIG. 7 illustrates an example review of system information interface provided as part of an example medical information system, according to an example embodiment of the present invention.

FIG. 8 illustrates an example allergy interface provided as part of an example medical information system, according to an example embodiment of the present invention.

FIG. 9 illustrates an example medication history interface provided as part of an example medical information system, according to an example embodiment of the present invention.

FIG. 10 illustrates an example examination information interface provided as part of an example medical information system, according to an example embodiment of the present invention.

FIG. 11 illustrates an example diagnosis interface as part of an example medical information system, according to an example embodiment of the present invention.

FIG. 12 illustrates an example diagnosis lookup window, provided as part of an example medical information system, according to an example embodiment of the present invention.

FIG. 13 illustrates an example medication interface provided as part of an example medical information system, according to an example embodiment of the present invention.

FIG. 14 illustrates an example procedure for processing patient medical information in support of a clinician's interaction with a patient, according to an example embodiment of the present invention.

FIG. 15 illustrates an example medical history table which may be provided as part of an example medical information system, according to an example embodiment of the present invention.

FIG. 16 illustrated an example review of system table that may be provided as part of an example medical information system, according to an example embodiment of the present invention.

FIG. 17 illustrates an example examination information table provided as part of an example medical information system, according to an example embodiment of the present invention.

FIG. 18 illustrates an example entry in an example pharmaceutical information table.

### DETAILED DESCRIPTION OF EXAMPLE EMBODIMENTS

An example medical information system may be provided, according to an example embodiment of the present invention. The example medical information system may incorporate an artificial intelligence or matching system using a standard diagnostic code set, e.g., the ICD-9 standard codes. The example medical information system may include interfaces for inputting and/or reviewing patient demographic and medical information, interfaces for inputting and/or reviewing positive findings and physical exam results, an interface for selecting a diagnosis, and an interface for selecting medications or procedures.

The example medical information system may include artificial intelligence or matching techniques to facilitate more rapid input of information by the clinician, and to suggest candidate diagnoses or medications based on the information collected by the system. The matching or artificial intelligence techniques may be based on standard diagnostic code set, e.g., the ICD-9 standard code set.

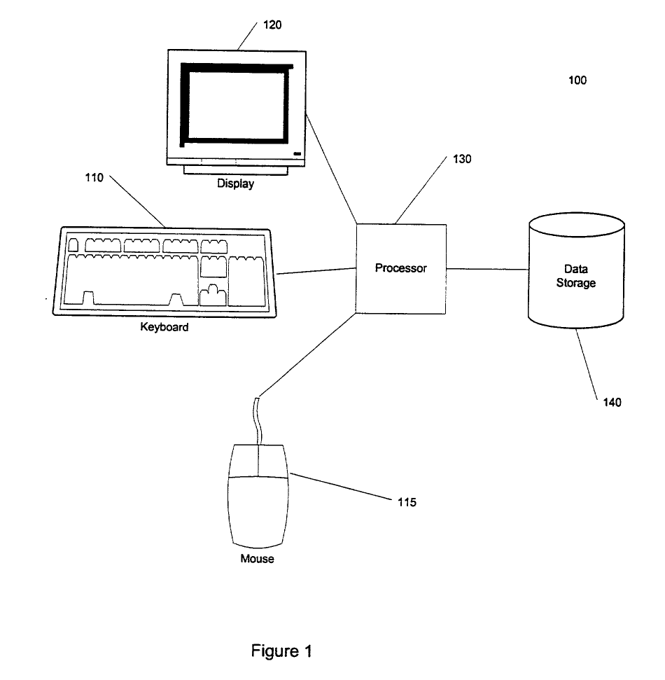

FIG. 1 illustrates an example high-level design for an example medical information system, according to an example embodiment of the present invention. The example medical information system may be provided in a stand alone mode on a single computer system 100, for example on a clinician's laptop computer. The computer system may include various input interfaces, e.g., a keyboard 110, or a mouse 115. It will be appreciated that other types of interfaces may be provided, e.g., a voice interface, a pen-based interface, or other mechanisms that enable a clinician to enter data in the system. The computer system may also include a display 120, which may be configured to allow for the display of information to the clinician. The example medical information system may also include a processor 130 for controlling the operation of the medical information system. The example medical information system may also include a storage system 140 directly accessible by the processor, for saving standard information needed by the medical information system, such as pharmaceutical information, symptom and diagnosis information, etc., as well as information regarding specific patients. The storage system 140 may include memory, disks, CD-ROMs, or other information storage technologies. The storage system 140 may also be used to store patient information entered by the clinician, or by others, e.g., a receptionist, nurse, or assistant.

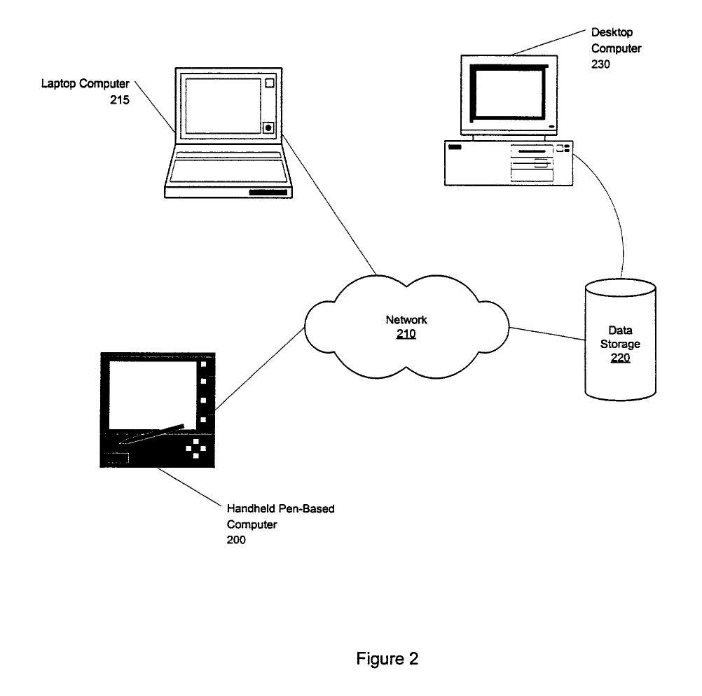

FIG. 2 illustrates an alternative example high-level design for the example medical information system. The alternative example high-level design may be provided as a distributed or networked computing system. A handheld computing device 200 may be used by the clinician to receive information from and input information to the medical information system. The processor which performs the processing required for the medical information system may be located on the hand-held computing device. It will be appreciated that the processor may also be located elsewhere in the system, with the handheld computing device merely providing input-output capabilities for the clinician. The handheld computing 200 device may be connected to a network 210. The network 210 may be wired or wireless, e.g., a wireless internet connection. Multiple clinicians may have access to the system, e.g., a second clinician may have access through a laptop computer 215. A storage system 220 may also be connected to the network. The storage system 220 may contain standard information used for all patients, such as pharmaceutical information, as well as information on particular patients. The storage system 220 may include memory, disks, CD-ROMs, or other information storage technologies. The storage system 220 may be provided as a file server, web server, database server, or other type of system used to hold and manage the stored information. The information contained in storage system 220 may be accessible to the handheld computing device 200 via the network 210. Other users may access the data store, e.g., to input patient medical history or update the standard information stored on the storage system 220, e.g., with a desktop computer 230 connected directly to the data store 220.

It will be appreciated that other possible arrangements of the elements of the medical information system may also be employed, e.g., using other conventional client-server or web-based architectures.

Example High Level Interface

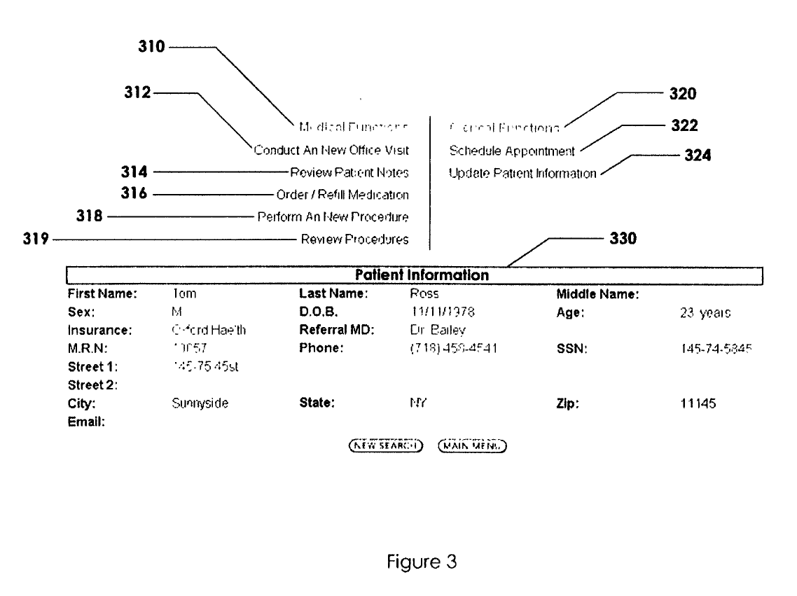

FIG. 3 illustrates an example high-level patient interface provided as part of an example medical information system, according to an example embodiment of the present invention. The example high-level interface may be provided as a custom designed interface, as a web page implemented in HTML or with other web-authoring tools or standards, as a window-based application in a client-server system, or with other conventional approaches to provided interactive user interfaces. It will be appreciated that other interfaces or layers of interfaces may be provided either separately or as part of the high-level patient interface, e.g., a password protected access screen may be included, user customization of the interfaces may be provided, etc.

The high level interface may include a patient menu configured to provide access to both medical and clerical functions needed to provide patient services. Medical functions may be selected using a plurality of buttons or hyperlinks 310. These buttons may include conducting an office visit or examination 312, reviewing patient notes or history 314, ordering or refilling a prescription 316, performing a procedure or lab test 318, or reviewing procedure or lab test results 319.

Clerical functions may also be selected using a plurality of buttons or hyperlinks 320. These buttons may include appointment scheduling 322 and updating patient information 324. A patient record 330 may also be displayed.

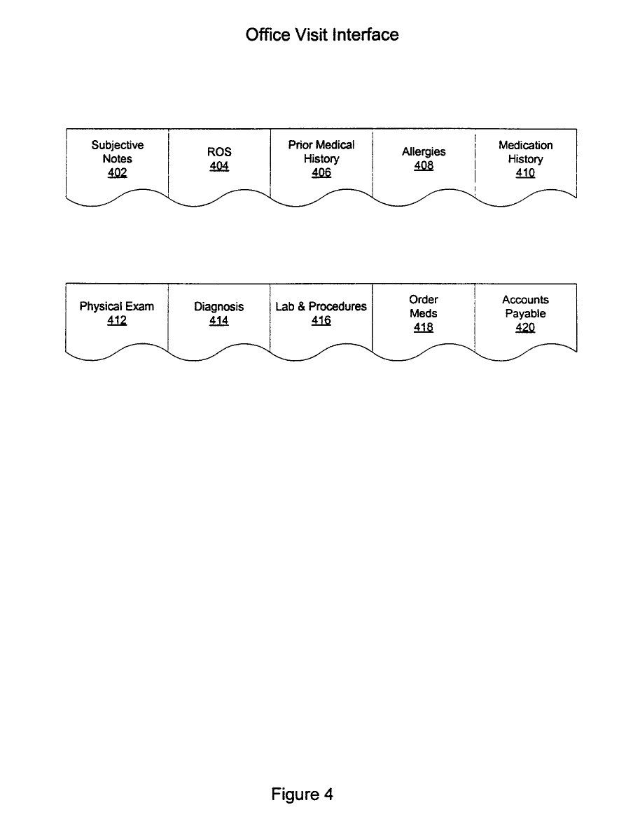

FIG. 4 illustrates an example office visit interface which may be provided as part of an example medical information system, according to an example embodiment of the present invention. Buttons or other selection mechanisms may be provided to allow a clinician or other person to access various elements of the example medical information system that are helpful to a clinician conducting an office visit or examination.

Button 402 may be configured to allow access to an interface for the entry of subjective notes about the patient and visit. Button 404 may be configured to allow access to an interface for the entry of review of system findings. Button 406 may be configured to allow access to an interface for the entering or viewing a patient medical history. Button 408 may be configured to allow access to an interface for the entering or viewing allergy information about the patient. Button 410 may be configured to allow access to an interface for the entry or review of a patient's medication history. Button 412 may be configured to allow access to an interface for the entry of physical exam findings. Button 414 may be configured to allow access to an interface for viewing of candidate diagnoses and selection of a diagnosis. Button 416 may be configured to allow access to an interface for ordering lab tests and procedures, e.g., radiology, pathology, or other specialty procedures. Button 418 may be configured to allow access to an interface for prescribing medication. Button 420 may be configured to allow access to an interface for generating billing and insurance records or reports.

It will be appreciated that many conventional approaches may be used to provide the high level and patient interfaces, e.g., a purely graphical interface, menus, keyword input, etc. It will also be appreciated that other arrangements of these interface may be employed, that may include less, or more information.

User Interface for Demographics

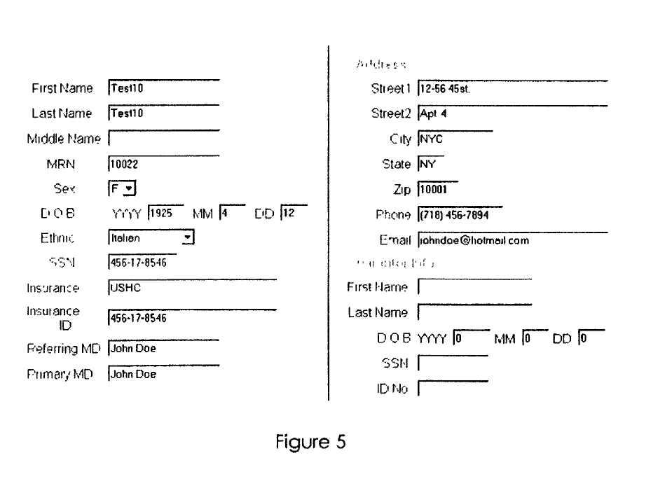

FIG. 5 illustrates an example patient demographic information interface provided as part of an example medical information system, according to an example embodiment of the present invention. The patient demographic information interface may be configured to allow the entry, viewing, and update of general information about a patient by a clinician or other person assisting a clinician, e.g., a medical office secretary or receptionist. FIG. 5 illustrates various types of patient information that may be input and viewed, e.g., name, sex, date of birth, a medical record number identifying the patient for the particular provider's system, ethnicity, social security number, insurance carrier and identification number, referring doctor, primary care doctor, address, telephone, e-mail address, and information on a billing guarantor such as a parent or guardian. Pull-down menus or a word-completion mechanism may be provided to facilitate easy entry and/or lookup of information for various fields. It will be appreciated that other fields may also be provided, and that the fields may be customized for particular medical offices or applications.

User Interface for Medical History

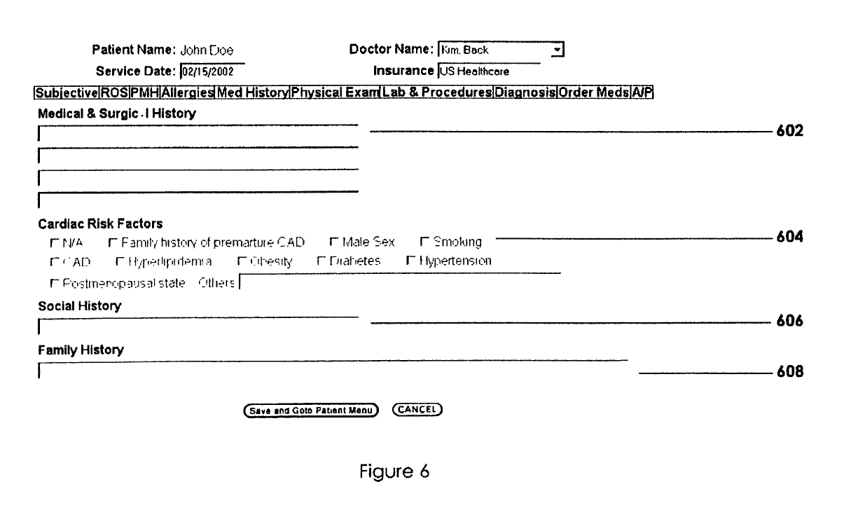

FIG. 6 illustrates an example medical history information interface provided as part of an example medical information system, according to an example embodiment of the present invention. The medical history information interface may be configured to allow input, review, and/or update of medical history data for a patient, as well as providing a clinician with a way of viewing or updating a patient's medical history.

The example medical history information interface may include general patient information at the top of the page medical history. One or more fields 602 may be provided to allow the input or display of various items in a patient's medical or surgical history. Pull-down menus or a word completion mechanism may be provided to facilitate rapid input of this information by a user.

The example medical history interface may include check-off boxes 604 for items of particular interest to the practitioner. Shown in FIG. 6 are check-off boxes 604 for cardiac risk factors, e.g., diabetes, smoking, etc., which may be especially suitable for use by a cardiologist or general practitioner. The check-off boxes 604 may be customized depending on the needs of the practitioner, e.g., an ophthalmologist may be provided with glaucoma risk factors.

The example medical history interface may include a social history field 606. The social history filed 606 may be configured to allow free text entry, or may have a pull-down or other facility for prompting the input or selection of items of social history such as marital status or education.

The example medical history interface may include a family history field 608. The family history field 608 may be configured to allow the entry of significant items in family medical history. Entries may be free-form, or may have pull-down or checkoff boxes. It will be appreciated that the operation of the family history field 608 may be customized depending on the needs of a clinician, e.g., different specialties may include different items, or different levels of detail. If more detail is required, separate fields may be provided for different family members.

User Interface for ROS Data

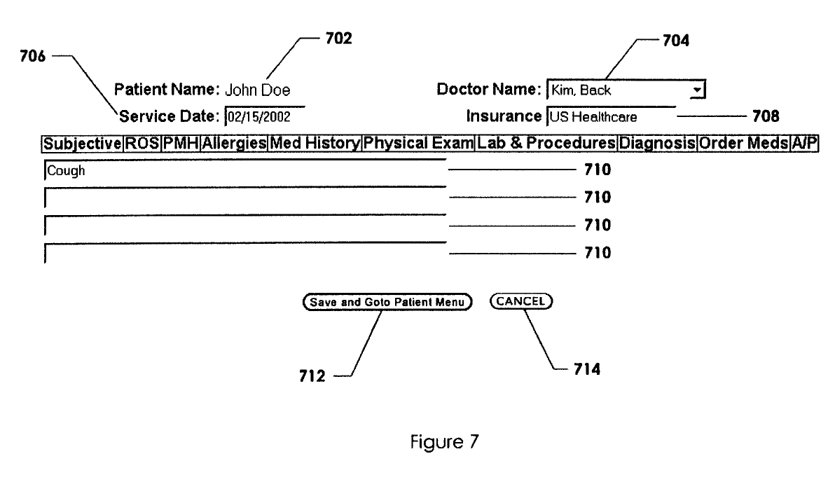

FIG. 7 illustrates an example review of system information interface provided as part of an example medical information system, according to an example embodiment of the present invention. The review of system (ROS) information interface may be configured to allows the input, review, and/or update of general symptom information about the patient. It will be appreciated that multiple interfaces may be provided for this purpose, e.g., a separate interface may be provided to record subjective notes on the patient.

Field 702 may display the patient's name. Filed 704 may display the doctor's name. Field 706 may display the service date, e.g., the date of an office visit that results in the entry of data by a clinician. Field 708 may display the patient's insurance carrier. Fields 702-708 may display information that was entered in the patient interface, or in the patient demographic information interface.

Fields 710 are entry fields which may be configured to allow the entry by the clinician of symptoms or complaints made by the patient. These entry fields may include a pull-down menu that allows a clinician user to select a finding from a list, e.g., by using a mouse, personal digital assistant stylus, or other pointing device. The entry fields may also allow a finding to be typed, and may provide a word completion capability to speed entry of information, e.g., typing a “c” may produce a pull-down menu of possible findings beginning with the letter “c”.

The entry of findings in the finding fields 710 may also be facilitated by having the entry fields prompt the clinician user with findings that were made during a previous examination or office visit. For example, these previous findings could be displayed at the head of the pull-down menu listing possible findings, or they could be highlighted in a list of findings. The previous findings may be retrieved from the patient's medical records, e.g., from a medical history database.

Button 712 may be configured to allow the user to return to the patient interface after saving the information entered in the review of system information interface. Button 714 may be configured to allow the user to cancel the entry of data in the review of system information interface and return to the patient interface.

Allergy Interface

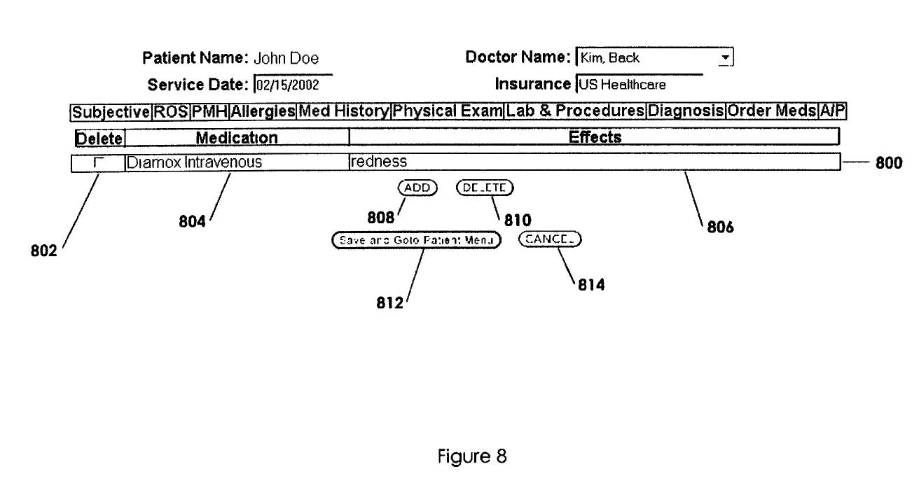

FIG. 8 illustrates an example allergy interface provided as part of an example medical information system, according to an example embodiment of the present invention. The allergy interface may be configured to allow a clinician or other user to enter, review, and/or update information about a patient's allergies, e.g., allergies to various pharmaceuticals. Information may also be loaded into the allergy interface from patient medical history or from prior examination records.

In addition to the general patient information fields at the top of the example allergy interface, a patient's allergies may be displayed (or entered) as a sequence of entries 800 (illustrated as rows) on the allergy interface. Each entry 800 may include several fields. A selection field 802 may provide a check-off box to allow selection of a particular entry. A second field 804 may indicate a medication or other substance to which the patient is allergic. Effects field 806 may indicate the effects of the substance on the patient. Both fields 804 and 806 may have pull-down menus to assist a user in selecting a medication or side-effect. The side-effects listed in field 806 may be pre-selected from a list of known side-effects for the medication in the 804 medication field in the same entry. A new entry button 808 may be configured to allow a user to create a new entry in the allergy interface. A delete button 810 may be configured to allow a user to delete a selected entry from the allergy interface. Save button 812 may be configured to allow the user to return to the patient menu after saving data entered in the allergy interface. Cancel button 814 may be configured to allow the user to cancel entries and return to the patient interface without saving data that has been input in the allergy interface.

Medication History Interface

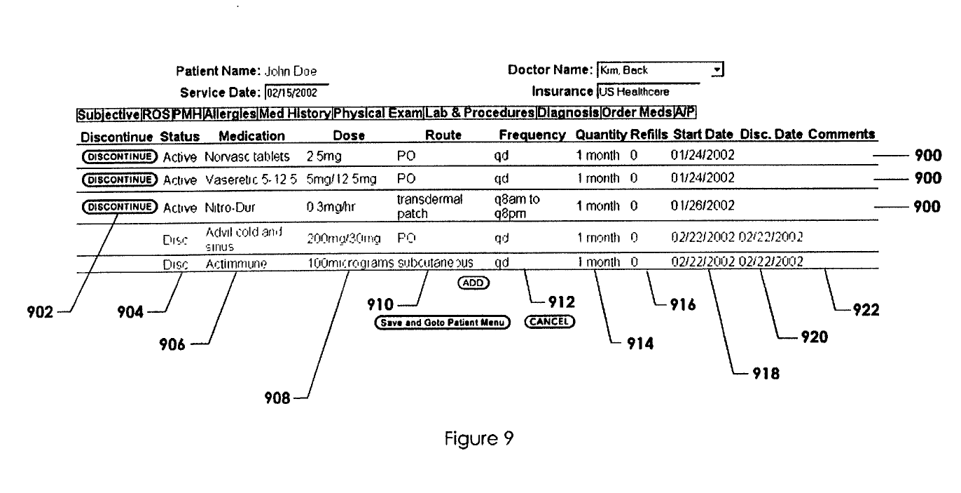

FIG. 9 illustrates an example medication history interface provided as part of an example medical information system, according to an example embodiment of the present invention. The medication history interface may be configured to allow a clinician or other user to enter, review, and/or update information about a patient's existing or previous medications. Information may be loaded into the medication history from prior examination records, e.g., from an office database. The medication history may also be entered by office personnel prior to a meeting with a clinician, or by the clinician themselves.

In addition to the general patient information fields at the top of the example medication history interface, several fields may be provided to facilitate the input and display of information about a patient's medication history. Current medications may be displayed as a sequence of entries 900 (illustrated as rows) on the medication history interface. Each entry 900 may include several fields. A first field 902 may provide a button that may be configured to allow the clinician to discontinue a medication that is presently active. A status field 904 may be configured to indicate whether a particular medication is currently active or not. A medication field 906 may indicate a particular medication, e.g., by name. A dose field 908 may indicate the prescribed dosage. A route field 910 may indicate the prescribed route, for example by mouth or intravenous. A frequency field 912 may indicate the prescribed frequency. A quantity field 914 may indicate the prescription quantity. A refill field 916 may indicate the number of prescribed refills. A start date 918 may indicate the date the medication was started. A discontinued date 920 may indicate the date a particular medication was discontinued. A comments field 922 may be configured to allow the clinician or other person to enter an additional comment on a particular medication, e.g., why the medication was prescribed.

It will be appreciated that the medication information interface need not be displayed as a grid or array. Other conventional approaches to display information may be used, e.g., icons with hidden features that may be revealed when an icon is selected.

User Interface for Exam Data

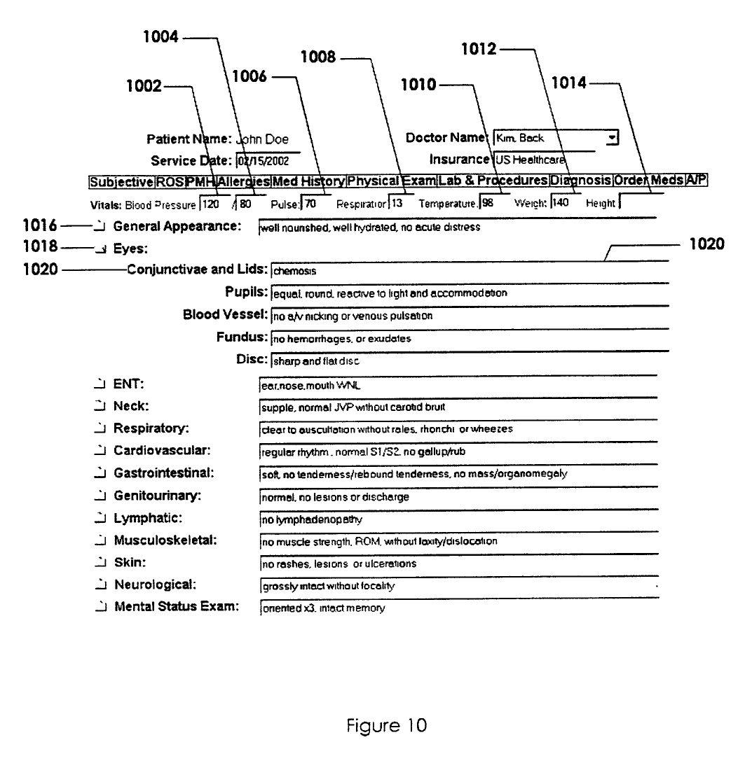

FIG. 10 illustrates an example examination information interface provided as part of an example medical information system, according to an example embodiment of the present invention. The examination interface may be configured to allow a clinician or person assisting a clinician to enter information about the results of a physical examination of a patient.

In addition to the standard patient information shown at the top of the examination interface, several fields may included to facilitate the entry of physical examination findings for a patient by a clinician.

A first set of fields may be provided for vital signs. Fields 1002 and 1004 may be configured to allow entry of and display of the patient's blood pressure. Field 1006 may be configured to allow input and display of the patient's pulse. Field 1008 may be configured to allow input and display of the patient's respiration rate. Field 1010 maybe configured to allow input and display of the patent's temperature. Field 1012 may be configured to allow input and display of the patient's weight. Field 1014 may be configured to allow input and display of the patient's height. It will be appreciated that other fields may also be included.

The remainder of the examination interface may have a set of hierarchically arranged fields, e.g., a tree-structured series of pull-down entries or folders. The hierarchical arrangement may facilitate the clinician's entry of findings on different organ systems

A first organ system 1016 may be configured to receive entries for “General Appearance”. A second organ system 1018 maybe for eyes. Organ system 1018 may have a plurality of organ subsystems, e.g., organ subsystem 1020 conjunctivae and lids. Other organ systems and subsystems may also be provided.

The clinician may expand or contract the level of detail for an organ system or subsystem, e.g., by opening and closing folders. The organ system folders may be opened and closed to display or hide the various subsystems. The system may be configured so that when a finding other than normal is entered, a more detailed set of fields is opened, prompting the clinician with a more detailed list of findings that may be chosen at the clinician's discretion.

Each organ system and subsystem may also have a pull-down menu including normal and abnormal findings for the particular system or subsystem. For example subsystem 1020 is shown with the abnormal diagnosis “CHEMSOSIS”. Abnormal diagnoses may be tagged with standard diagnosis codes, for example ICD-9 codes. For example “Chemosis” may be tagged with the ICD-9 code 372.73. To assist the clinician in entering specific findings, a search function or word-matching capability may also be included.

The pull-downs for each system or subsystem may also be configured to automatically prompt the clinician with a finding that was made in a previous examination. Because the same finding may commonly be made in successive examinations, this automatic display may save the clinician from having to search for the appropriate finding.

The pull-downs or prompts may also be customized to provide greater detail based on a clinician's preferences or specialty, or based on facts in the patient's medical history. For example, a cardiologist may receive a more detailed set of prompts for cardiovascular or respiratory findings.

Diagnosis Interface

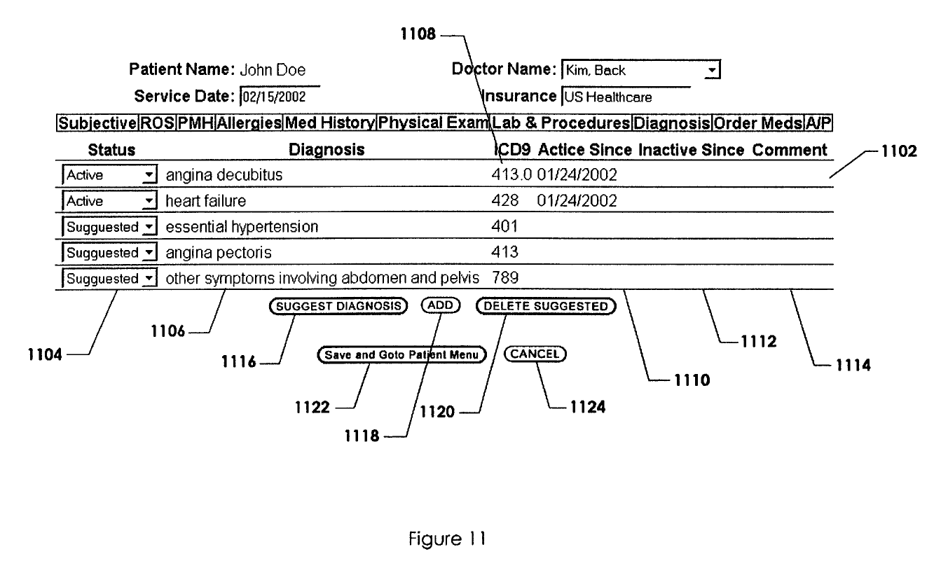

FIG. 11 illustrates an example diagnosis interface provided as part of an example medical information system, according to an example embodiment of the present invention. The diagnosis interface may display general patient information at the top of the screen.

The diagnosis interface may display a number of suggested or selected diagnoses as entries 1102 in a diagnosis display table. An example entry 1102 (illustrated as a row) is shown for illustration, along with several other example entries. The example entry 1102 may include several fields for input or display of diagnosis information. Status field 1104 may indicate the status of a diagnosis, e.g., whether the diagnosis is a diagnosis suggested by the system or a diagnosis selected by the clinician. A pull-down menu may be provided as part of status field 1104, which may be configured to allow the clinician to easily change the status of the diagnosis. The diagnosis field 1106 may be configured to display the name of the diagnosis, or other unique identifiers which may identify the diagnosis to the clinician. The ICD9 field 1108 may be configured to display the ICD-9 code for the diagnosis. The diagnosis interface may be configured to automatically change the name of the diagnosis when the clinician selects a different ICD-9, or to automatically change the ICD-9 field when the clinician selects a different named diagnosis. An active since field 1110 may indicate a date which the diagnosis has been active since. This active date may be downloaded from the patient's medical history record, or entered by a user. An inactive date 1112 may give a date which the diagnosis has been inactive since. This inactive date may be downloaded form the patient's medical history record. A comment field 1114 may be configured to allow the clinician to input a comment to the diagnosis, e.g., a plain language note or explanation.

A suggested diagnosis button 1116 may be clicked by the clinician to have the system display a list of candidate or possible diagnoses, based on information that was collected in the patient medical history interface, exam interface, medication history interface, etc. An add button 1118 may be configured to allow the clinician to normally enter a new diagnosis that is not presently displayed. A delete button 1120 may be configured to allow the clinician to delete a diagnosis. A save button 1122 may be configured to allow the clinician to save the diagnoses and return to the patient interface. A cancel button 1124 may be configured to allow the clinician to cancel any entries made in the diagnosis interface and return to the patient interface without saving.

Several approaches may be employed when clinician requests a list of candidate diagnoses. Candidate diagnoses may include all previous diagnoses, e.g., loaded from the patient's medical history. Candidate diagnoses may also include all diagnoses that are related to the patient's current medications, e.g., a patient with an insulin prescription likely has some form of diabetes. These diagnoses may be determined by matching the patient's medication history with information on which diagnoses indicate particular medications. Candidate diagnoses may be also be selected based on ROS and physical exam information, e.g., by matching the patients symptoms and clinician's physical findings with stored information associating findings with diagnoses.

In addition, when the clinician selects a general diagnosis, the interface may prompt the clinician for a more specific diagnosis. For example, the entry of a whole number ICD-9 may result in prompting the clinician with the decimal subcodes for the selected diagnosis.

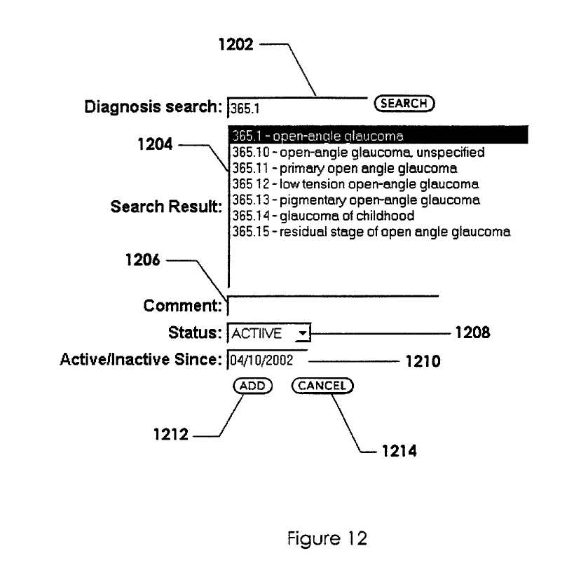

FIG. 12 illustrates an example diagnosis lookup window, provided as part of an example medical information system, according to an example embodiment of the present invention. The diagnosis lookup window may be displayed when a user attempts to add a diagnosis, e.g., by clicking the add button on the diagnosis interface. Field 1202 may be configured to allow a clinician to enter a search term. For example, the clinician may enter an English-language or technical term or a standard diagnosis code, e.g., ICD-9 code. When the clinician presses the search button (or hits return after entering a term) a search may be conducted and corresponding diagnoses may be displayed in a search result field 1204. Both the standard diagnosis code (e.g., ICD-9) and the name of the diagnoses may be displayed. Thus, a clinician may search for a name based on a code or partial name, and may also search for a code based on a name or partial name. More detailed subdiagnoses may also be displayed, when a diagnosis is given as a result of a search.

A comment field 1206 may be configured to allow the clinician to enter a comment. A status field 1208 may be configured to allow the clinician to see a status for the diagnosis, and to change the status using a pull-down menu to select a new status. An Active/Inactive Since field 1210 may be configured to display a date when the present diagnosis became active or inactive. The active/inactive field 1208 may also be configured to allow the clinician to enter or change the active/inactive since date.

An add button 1212 may be configured to allow the clinician to add the selected diagnosis to the list of diagnoses associated with the patient and displayed on the diagnosis interface. A cancel button 1214 may be configured to allow the clinician to cancel the search without changing the list of diagnoses associated with the patient and displayed on the diagnosis interface. Pressing either the add or cancel button may return the user to the diagnosis interface.

Medication Interface

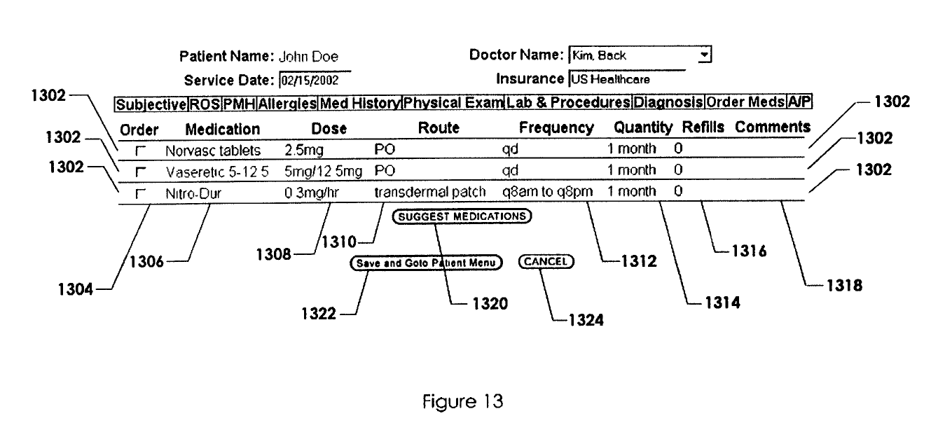

FIG. 13 illustrates an example medication interface provided as part of an example medical information system, according to an example embodiment of the present invention. The example medication interface may be configured to suggest possible medications, and to assist a clinician in selecting and ordering medications for the patient.

In addition to standard patient information fields shown at the top of the medication interface, entries 1302 (illustrated as rows) may be displayed on the medication interface for each medication that is currently prescribed or suggested by the system. Each entry 1302 may include several fields for display of information to the clinician and input of information by the clinician. An order field 1304 may be selected by a clinician to order a selected medication. A medication field 1306 may display the name of the medication. A dosage field 1308 may display a dosage for the medication. A pull-down menu may prompt the clinician with suggested dosages for the patient, e.g., common dosages, or dosages adjusted by the age or weight of the patient. A route field 1310 may be configured to allow the clinician to specify the route of the medication. A frequency field 1312 may be configured to allow the clinician to specify the frequency of the medication. A quantity field 1314 may be configured to allow the clinician to specify a quantity for the prescribed medication. A refill field 1316 may be configured to allow the clinician to specify a number of refills for the prescription. A comment field 1318 may be configured to allow the clinician to add a comment to the prescription for a particular medication.

The system may automatically delete contraindicated medications from a list of candidate medications. Alternatively, or in addition, contraindicated medications may be flagged or highlighted to bring the contraindication to the attention of the clinician.

The system may also be configured to display candidate medications in a rank order. For example, the clinician may be allowed to custom program the system to indicate certain medications are preferred for particular conditions, or as substitutes for other medications. The system may automatically rank a particular medication based on the patient's insurance coverage, e.g., if the patients insurance coverage only pays for a generic, the generic may be ranked ahead. If the medical information system is sponsored by a particular pharmaceutical vendor, or managed care provider, certain clinically similar pharmaceuticals may be omitted or ranked higher, depending on the sponsor's preference. For example, a managed care provider may, based on purchasing considerations or measured track record prefer a single brand or substance.

It will be appreciated that other interfaces and/or capabilities may be provided. For example, interfaces may be provided to automatically generate billing, insurance, and prescription forms.

Advertisements may be provided to the clinician, either as part of the medication interface, or as part of one of the other interfaces. These advertisements may be based on sponsorship, e.g., from a drug company. The advertisements may targeted, e.g., by tailoring the advertisements to the specialty of the clinician or in response to patient demographics or active diagnosis.

Example Procedure

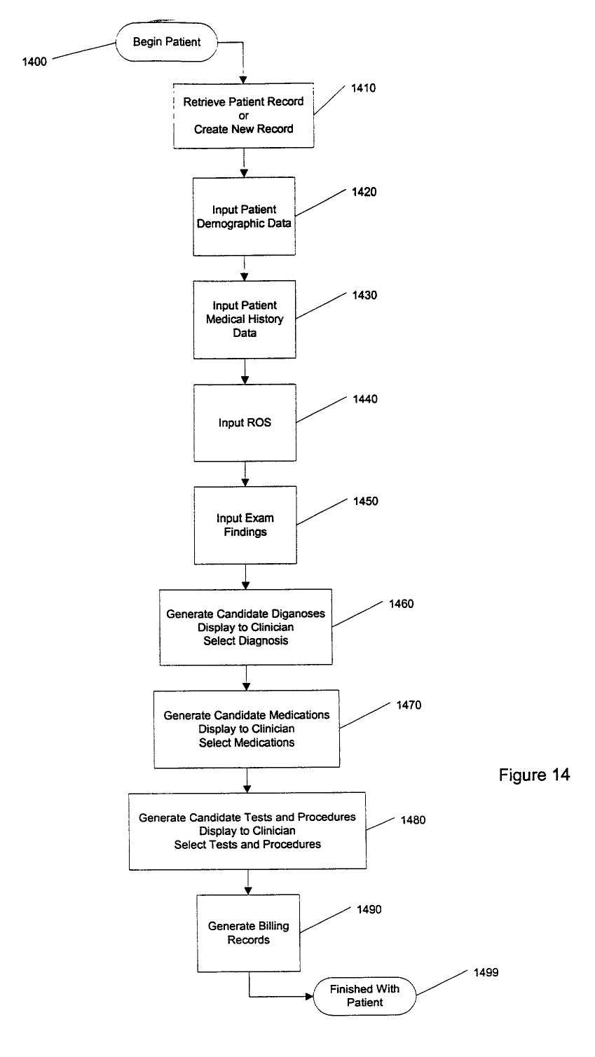

FIG. 14 illustrates an example procedure for processing patient medical information in support of a clinician's interaction with a patient, according to an example embodiment of the present invention. The example procedure may be provided as part of the example medical information systems.

In 1410 a patient may be selected. The example medical information system may include a database of a clinician's patients, allowing a record to be retrieved for the patient. For a new patient, data may need to be entered, e.g., from a patient information sheet, or downloaded from another source.

In 1420, patient demographic data may be input. If the patient is a new patient, data may need to be entered in its entirety. Otherwise, data may be retrieved from an office database, checked and updated.

In 1430, information on the patient's medical history and current medications may be collected. Information may be entered by a user, or downloaded from a historical database. Entry of medical history may be facilitated by looking up entries in a medical history table, yielding standard names and diagnostic codes. Medication history entry may be facilitated by matching entries with entries in a medication information table or other source of medication information.

It will be appreciated that the information in 1420 and 1430 may be provided or entered by the clinician, the patient, or by some person assisting the patient or clinician, e.g., a secretary, receptionist, or nurse.

In 1440, symptom information about the patient may be input. This information may be provided by the clinician, but may also be entered by a person assisting the clinician. In addition to positive physical findings, subjective information about the patient, such as patient complaints, general appearance, or smoking, may also be input. Entries may be matched against a review of system (or symptom) information table. Matching may help insure standard names and/or classification codes are assigned to symptom information.

In 1450, the clinician may perform a physical examination of the patient. Specific physical findings form the physical examination may be recorded. The physician may be prompted with findings based on information already collected, e.g., physical findings in a previous physical examination or findings consistent with the patient's medical history. Findings may also be looked-up or matched with a table or database of standard examination results. This matching may help insure standard names and/or associated diagnosis codes are assigned to examination findings. Findings may also be tested for reasonableness and flagged if problematic. Other forms of error-checking may also be provided.

In 1460, candidate diagnoses may be generated. Candidate diagnoses may be determined based on a patient's medical history, medication history, symptoms, and physical exam findings. The current patient's current and past medications may suggest certain diagnoses may be present, e.g., all diagnoses that indicate a particular medication may be listed in a medication information table. Physical findings or exam results may also suggest diagnoses, for example, corresponding diagnostic codes in a medical history information table, or in a physical exam information table. The candidate diagnoses may be displayed to the clinician. It will be appreciated that other approaches for generating candidate diagnoses may also be provided, e.g., rule-based systems or other artificial intelligence techniques. The clinician may select a candidate diagnoses, or may input a different diagnosis. The clinician may be prompted for a more detailed diagnosis, if a general diagnosis is entered.

In 1470, candidate medications may be generated. Candidate medications may be determined based on the diagnoses that were selected in 1460. All medications that are indicated by chosen diagnoses may be displayed for potential selection by the clinician.

Some medications may be indicated for a general diagnosis code, e.g., a three digit ICD-9 code such as “123”. A clinician may select a more particular diagnosis, e.g. a five digit ICD-9 code such as “123.45”. The system may generate all medications indicated for both the more particular diagnosis, and for more general diagnoses that include the particular diagnosis. A clinician selected diagnosis having ICD-9 code “123.45” may result in the system displaying all medications indicated by the general and more specific ICD-9 codes “123”, “123.4”, and “123.45”.

Medicines that are contraindicated may be deleted, or flagged, e.g., with a red highlight. Medications may be rank ordered based on physician preference, insurance coverage, price etc. The clinician may select medications from the list, or prescribe other not on the list.

In 1480, candidate tests or procedures, e.g., radiology, pathology, or other specialty procedures, may generated and presented to the clinician. The clinician may order tests or procedures, either by selecting candidate procedures, or by inputting other procedures.

In 1490, a billing record may be generated for the office visit or other interaction with the clinician. Prescriptions, test and procedure orders, and insurance forms may also be generated automatically. A record of the entire transaction, including examination results, prescriptions, and tests and procedures may be saved as part of the patient's medical history records.

It will be appreciated that other steps and operations may be included in the example procedure. For example, the example procedure and system may have access to a list, database, or library of educational material. The educational material may be associated with indication codes, similar to the way medications are flagged. The system may automatically generate a list of candidate educational for the patient based on the patient's diagnosis, medication, or a procedure which the patient receives. This material may then be provided automatically, without intervention of the clinician, e.g., by automatically e-mailing the material after receiving patient consent or by sending an e-mail instruction to provide the material to a receptionist or other person assisting the clinician. Alternatively, a menu of available material that is indicated may be provided to the clinician, and the clinician may designate which pieces of education material are to be provided to the patient.

Example Internal Data Structures

Several data structures may be provided as part of the example medical information system, according to an example embodiment of the present invention. These data structures may include information used in the operation of the medical information system. These data structures may include a patient medical history table, a review of system (or symptom) table, a physical exam table, and a medication table. As provided in the example medical information system, these data structures need not be used to store information about particular patients; information about particular patients may be stored by the medical information system in other data structures or databases.

It will be appreciated that the particular data structures or representations for these tables may be varied, e.g., the tables may be stored in arrays, in linked lists, in relational database, or with other conventional data structures or data storage approaches. It will be appreciated that the tables may be stored separately, or may be combined using a larger and more complex data structure. It will also be appreciated that these tables need not all be stored in any particularly location, e.g., they may be stored on the same hardware platform that provides the interface for a clinician, they may be stored in an office database that centralizes such information for a medical office, or they may be accessed from a remote location over a network, e.g., over the internet from a centrally provided web-server.

Example Patient History Table

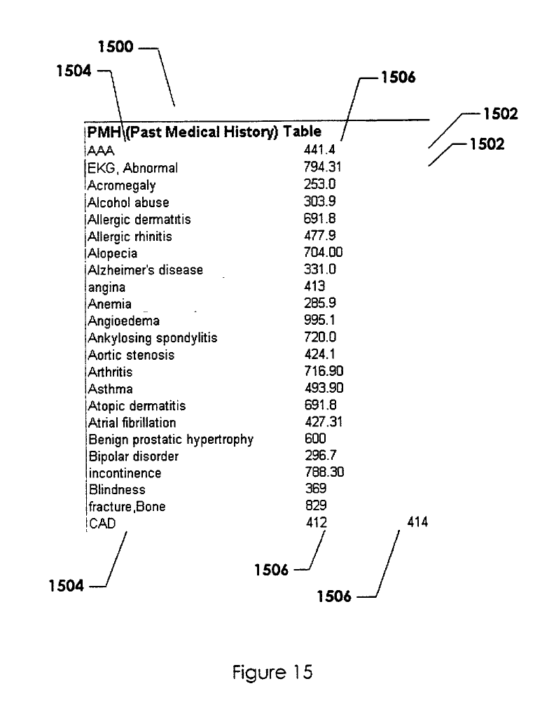

FIG. 15 illustrates an example medical history table 1500 which may be provided as part of an example medical information system, according to an example embodiment of the present invention. The example patient medical history may be used to store and classify possible diagnoses or conditions that may be included in a patient's medical history record.

The medical history table 1500 may include multiple entries 1502 (illustrated as rows). Each entry 1502 may include a name field 1504 that gives the name of a diagnosis. Each entry may also associate with the name field 1504 one or more corresponding standard diagnosis code fields 1506, which may contain standard codes, e.g., ICD-9 codes, for the conditions indicated in the name field. It will be appreciated that some medical history entries may have multiple standard diagnosis code fields, e.g., CAD is shown in FIG. 15 with the ICD-9 codes “412” and “414”.

It will be appreciated that not all entries 1502 are required to have associated standard diagnosis codes. For example, smoking, a matter of great interest to physicians, does not have an ICD-9 code. These entries may be given without codes, or alternatively may have system specific codes or symbols that allow these conditions without standard codes to be conveniently tracked and matched. Other information may also be included, e.g., names of the diagnosis codes.

Example Review of System Table

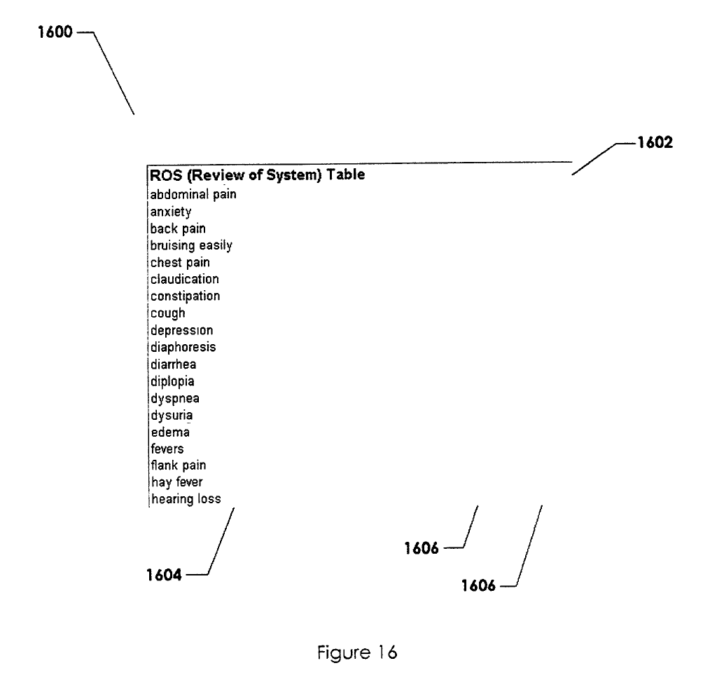

FIG. 16 illustrates an example review of system table 1600 that may be provided as part of an example medical information system, according to an example embodiment of the present invention. The example review of system table may be provided to allow convenient linking of positive physical findings or symptoms with standard diagnosis codes, e.g., ICD-9 codes.

The review of system table may include multiple entries 1602. Each entry 1602 may include a name field 1604 that gives the name of a positive physical finding. Each entry may also associate with the name field 1604 one or more corresponding diagnosis code fields 1606, which may contain standard codes, e.g., ICD-9 codes for diagnosis that are associated with the positive findings indicated in the name field.

It will be appreciated that not all entries in the field are required to have associated standard diagnosis codes. For example, smoking, a matter of great interest to physicians, does not have an ICD-9 code. Some entries may have system specific codes that allow these conditions without standard codes to be conveniently tracked and matched. Other information may also be included, e.g., names of the corresponding diagnoses, indications of symptom correlation or additional diagnoses information.

Example Examination Information Table

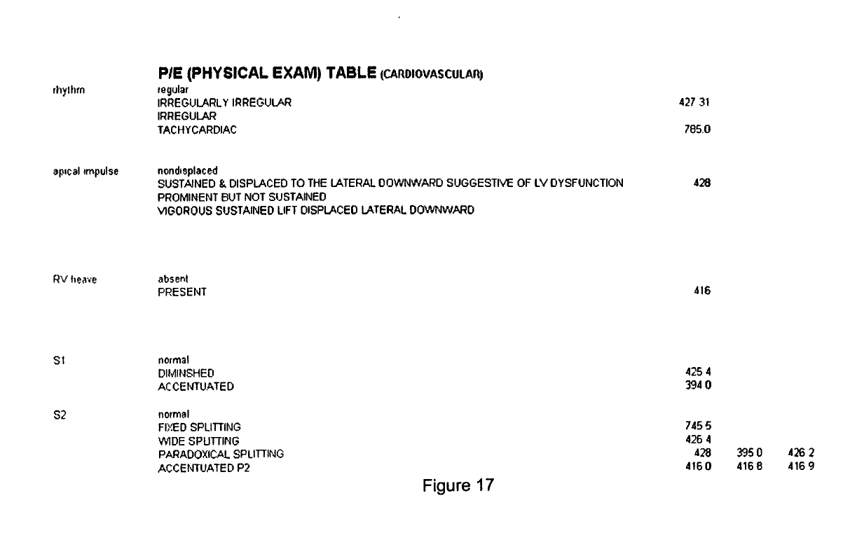

FIG. 17 illustrates an example examination information table provided as part of an example medical information system, according to an example embodiment of the present invention. The table may associate organ systems with physical findings. For each associated pair of physical findings, one or more diagnosis codes may be identified.

The illustrated example only shows a partial entry for the cardiovascular system. Different subsystem are shown, e.g., rhythm and apical impulse. For each subsystem, possible physical exam findings are shown together with corresponding diagnosis codes. For example a finding of tachycardiac rhythm would suggest a diagnosis 785.0. Some findings may have multiple diagnoses, e.g., accentuated P2 for S2 may suggest 416.0, 416.8, or 416.9.

It will be appreciated that any conventional data structure linking systems, findings, and diagnosis may be employed; the tabular format shown need not be used but may be replaced, e.g., by a linked list or tree.

Example Pharmaceutical Information Table

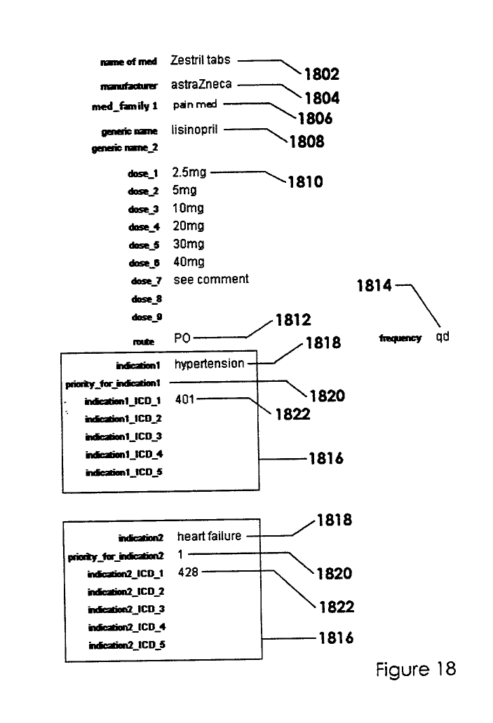

FIG. 18 illustrates an example entry in a pharmaceutical information table. It will be appreciated that the pharmaceutical information table need not be provided as an array, but that any conventional data structure may be used, e.g., a relational database, a linked list, a tree, etc.

An entry in the example pharmaceutical information table entry may include a medication name field 1802. The entry may also include a manufacturer field 1804. A plurality of family fields 1806 may indicate the family or type of medications. A generic field 1808 may indicate the generic name for the medication. A plurality of dosage field 1810 may indicate common dosages for the medication. A route field 1812 and a frequency field 1814 may indicate the route and frequency of the medication. The entry may include one or more indication subentries 1816. Each indication subentry may have an indication name field 1818. The indication subentry 1816 may also include a priority field 1820 which may be used to indicate the priority of this medication for the particular indication. The indication subentry 1816 may also include one or more standard diagnosis codes 1822, e.g., ICD-9 codes, for the particular indication associated with the indication subentry 1816.

Modifications

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

1. A medical information system for facilitating the treatment of a patient by a clinician, comprising:
a processor;
at least one input device readable by the processor;
a demographic information interface configured to allow the input of patient demographic information for the patient from the at least one input device;
a medical history interface configured to allow the input of medical history information for the patient from the at least one input device;
an examination interface configured to allow the input of examination information for the patient from the at least one input device; and
a diagnosis interface configured to allow the clinician to select a diagnosis using the at least one input device.

2. The medical information system of claim 1, further comprising:
a symptom table accessible to the processor.

3. The medical information system of claim 2, wherein
the symptom table includes at least one symptom table entry associating a symptom with at least one diagnosis.

4. The medical information system of claim 3, wherein
the at least one diagnosis associated with the symptom is represented by an ICD-9 diagnosis code in the at least one symptom table entry.

5. The medical information system of claim 1, further comprising:
a physical exam table accessible to the processor.

6. The medical information system of claim 5, wherein
the physical exam table includes at least one physical exam table entry associating an organ system and a possible physical finding.

7. The medical information system of claim 6, wherein
the physical exam table further includes at least one candidate diagnosis associated with the organ system and the possible physical finding.

8. The medical information system of claim 7, wherein
the candidate diagnosis is represented by an ICD-9 diagnosis code.

9. The medical information system of claim 1, further comprising:
a medical history table accessible by the processor including information about the patient's prior medical history.

10. The medical information system of claim 9, wherein
the past medical history table includes at least one medical history table entry which includes a past diagnosis.

11. The medical information system of claim 10, wherein
the at least one past medical history table entry further includes an indication of whether the past diagnosis is presently active.

12. The medical information system of claim 10, wherein
the at least one medical history table entry further includes an indication of the time when the past diagnosis was active.

13. The medical information system of claim 9, wherein
the medical history table is configured to receive medical history data input using the medical history interface.

14. The medical information system of claim 9, wherein
information contained in the medical history table is viewable by the clinician using the medical history interface.

15. The medical information system of claim 9, wherein
the medical history table is configured to receive medical history data downloaded from other systems.

16. The medical information system of claim 15, wherein
the medical history interface is configured to allow the clinician to update medical history data downloaded from other systems.

17. The medical information system of claim 1, further comprising:
a pharmaceutical information table accessible to the processor.

18. The medical information system of claim 17, wherein
the pharmaceutical information table includes at least one pharmaceutical information table entry associating a pharmaceutical with an indication.

19. The medical information system of claim 18, wherein
the indication corresponds to an ICD-9 diagnosis code.

20. The medical information system of claim 18, wherein
the pharmaceutical information table entry further includes contraindication information for the pharmaceutical.

21. The medical information system of claim 18, wherein
the pharmaceutical information table entry further includes recommended dosage information for the pharmaceutical.

22. The medical information system of claim 18, wherein
the pharmaceutical table entry further includes recommended frequency information for the pharmaceutical.

23. The medical information system of claim 1, further comprising
a procedure table accessible to the processor.

24. The medical information system of claim 23, wherein
the procedure table includes a procedure table entry associating a procedure with a candidate diagnosis.

25. The medical information system of claim 23, wherein
the procedure table entry includes information associating the procedure with a billing code.

26. The medical information system of claim 1, further comprising:
an examination information table, including at least one examination information table entry associating a possible finding with an organ system.

27. The medical information system of claim 26, wherein
the at least one examination information table entry includes multiple possible findings with a single organ system.

28. The medical information system of claim 26, wherein
the at least one examination information table entry further associates the organ system and finding with at least one candidate diagnosis.

29. The medical information system of claim 1, wherein
the examination interface is configured to prompt the clinician with possible findings for an organ systems.

30. The medical information system of claim 29, wherein
the examination interface is configured to prompt the clinician with more specific candidate findings for an organ system after a general finding has been chosen by the clinician.

31. The medical information system of claim 29, wherein
the examination interface is configured to prompt the clinician with more specific candidate findings for a particular organ system based on the clinician's field of specialty.

32. The medical information system of claim 29, wherein
the examination interface is configured to prompt a clinician user with candidate findings based on findings made in a previous examination.

33. The medical information system of claim 1, wherein
the diagnosis interface is configured to prompt the clinician with candidate diagnoses.

34. The medical information system of claim 33, wherein
the diagnosis interface is configured to prompt the clinician for a more specific diagnosis after a general diagnosis has been selected by the clinician.

35. The medical information system of claim 33, wherein
candidate diagnoses are selected based in part on the patient's medical history.

36. The medical information system of claim 33, wherein
candidate diagnosis are selected based in part on the patient's current medications.

37. The system of claim 1, further comprising:
a medication selection interface configured to allow the selection of a prescribed medication using the at least one input device.

38. The system of claim 37, wherein
the medication selection interface is configured to prompt the user with candidate medications based on a diagnosis selected by the clinician using the diagnosis interface.

39. The medical information system of claim 37, wherein
the medicine selection interface is configured to eliminate candidate medications based on contraindications in the pharmaceutical table.

40. The medical information system of claim 37, wherein
the medicine selection interface is configured to flag candidate medications based on contraindications in the pharmaceutical table.

41. The medical information system of claim 37, wherein
the medication selection interface is configured to display candidate medications in a rank order based on pre-programmed clinician preferences.

42. The medical information system of claim 37, wherein
the medication selection interface is configured to display candidate medications in a rank order based on the patient's insurance coverage.

43. The medical information system of claim 37, wherein
the medication selection interface is configured to display candidate medications in a rank order based on sponsorship by drug suppliers to the provider of the medical information system.

44. The medical information system of claim 1, wherein
the same input device is used for each of the demographic information interface, medical history interface, examination interface, and diagnosis interfaces.

45. The medical information system of claim 1, wherein
the demographic information interface and medical history interface are configured to allow entry of patient demographic information and patient medical history information from a separate input device by a person other than the clinician.

46. A medical information system for facilitating the treatment of a patient by a clinician, comprising:
a processor;
at least one input device readable by the processor;
a demographic information interface configured to allow the input of patient demographic information for the patient from the at least one input device;
a medical history interface configured to allow the input of medical history information for the patient from the at least one input device;
an examination interface configured to allow the input of examination information for the patient from the at least one input device;
a diagnosis interface configured to prompt the clinician with candidate diagnoses based in part on the patient's medical history and to allow the clinician to select a diagnosis using diagnosis interface;
a symptom table accessible to the processor, the symptom table including at least one symptom table entry associating a symptom with at least one diagnosis;
a physical exam table accessible to the processor, the physical exam table including at least one physical exam table entry associating an organ system and a possible physical finding, and including at least one possible diagnosis associated with the organ system and the possible physical finding;
a medical history table accessible by the processor including information about the patient's prior medical history;
a pharmaceutical information table accessible to the processor, the pharmaceutical information table including at least one pharmaceutical information table entry associating a pharmaceutical with an indication;
a procedure table accessible to the processor, the procedure table including a procedure table entry associating a procedure with a candidate diagnosis; and
an examination information table, including at least one examination information table entry associating a possible finding with an organ system.

47. A method for facilitating a clinician's medical examination of a patient, comprising:
receiving demographic data for the patient;
receiving patient medical history data for the patient;
receiving current medication data for the patient;
receiving examination data for the patient;
displaying at least one candidate diagnosis;
receiving a selected diagnosis from the clinician; and
generating candidate medications as a function of the selected diagnosis.

48. The method of claim 47, further comprising:
generating billing codes as a function of the selected diagnosis.

49. The method of claim 47, further comprising:
generating at least one candidate diagnosis as a function of the current medication data.

50. The method of claim 47, further comprising:
prompting the clinician for an examination finding on an organ system; and
receiving examination data from the clinician in response to the prompt.

51. The method of claim of 47, further comprising:
displaying a plurality of candidate diagnoses.

52. The method of claim 47, further comprising:
prompting the clinician to select a more specific diagnosis after a general selected diagnosis has been received from the clinician.

53. The method of claim 47, further comprising:
displaying the candidate medications in a rank order based on the clinician's pre-programmed preferences.

54. The method of claim 47, further comprising:
displaying the candidate medications in a rank order based on the patient's insurance coverage.

55. An article of manufacture comprising a computer-readable medium having stored thereon instructions adapted to be executed by a processor, the instructions which, when executed, define a series of steps to be used to control a method facilitating a clinician's medical examination of a patient, said steps comprising:
receiving demographic data for the patient;
receiving patient medical history data for the patient;
receiving current medication data for the patient;
prompting the clinician for an examination finding on an organ system;
receiving examination data for the patient from the clinician in response to the prompting;
generating at least one candidate diagnosis;
displaying the at least one candidate diagnosis;
receiving a selected diagnosis from the clinician; prompting the clinician to select a more specific diagnosis after a general selected diagnosis has been received from the clinician;
generating candidate medications as a function of the selected diagnosis; and
displaying the candidate medications in a rank order based on pre-programmed preferences.
